(19) United States
(12) Patent Application Publication
(10) Pub. No.: US 2013/0215448 A1
(43) Pub. Date: Aug. 22, 2013

(54) Machine-readable data pattern associated with physical defects on printable media supply

(71) Applicants: Glenn T. Gentile, San Diego, CA (US); Morad M. Samil, La Jolla, CA (US)

(72) Inventors: Glenn T. Gentile, San Diego, CA (US); Morad M. Samil, La Jolla, CA (US)

(73) Assignee: Hewlett-Packard Development Company, L.P., Houston, TX (US)

(21) Appl. No.: 13/882,629

(22) PCT Filed: Oct. 30, 2010
(86) PCT No.: PCT/US10/54890

§ 371 Date: Apr. 30, 2013

(51) Int. Cl. B41F 33/00

(52) U.S. Cl. CPC B41F 33/0036
USPC 358/1.13; 358/3.28

(57) ABSTRACT

Information includes at least a location of each physical defect on a printable media supply. A machine-readable pattern associated with the information is added to the printable media supply.

### BACKGROUND

Printing systems span the gamut from small printing devices intended to be placed on desktops within office and residential environments, to large industrial printing systems that can quite literally take up entire rooms. The latter type of printing system commonly prints on large rolls of paper or other types of printable media supplies, such as textiles. These large rolls of paper can sometimes exceed hundreds of feet in length.

### BRIEF DESCRIPTION OF THE DRAWINGS

FIG. 1 is a flowchart of a method performed after a printable media supply has been manufactured and before the printable media supply has been provided to a customer, according to an example of the disclosure.

FIG. 2 is a diagram depicting a representative printable media supply that includes defects, according to an example of the disclosure.

FIGS. 3A and 3B are flowcharts of a method performed after the printable media supply has been provided to a customer, according to an example of the disclosure.

FIG. 4 is a diagram depicting how printing of print jobs on the representative printable media supply of FIG. 2 may be planned, according to an example of the disclosure.

FIG. 5 is a block diagram of a printing system, according to an example of the disclosure.

### DETAILED DESCRIPTION

As noted in the background section, some types of printing systems print on large rolls of paper or other types of printable media supplies that can exceed tens of thousands of feet in length when initially manufactured. The manufacture of such a large printable media supply is likely to involve the inadvertent creation of a number of physical defects on the printable media supply. Examples of such physical defects include, for instance, areas on the printable media supply at which the media has not been properly coated. Printing over the physical defects can lead to impairment of the quality of the printed image.

Traditionally, defects are removed from a printable media supply before shipping the supply to a customer. A larger roll of printable media than that which will be shipped to customers may have a number of defects. The roll is cut to remove each defect, and then spliced back together. When it comes time to cut the roll into smaller rolls of hundreds of feet, for instance, of printable media that are to be shipped to customers, if any of the smaller rolls include a splice, then the entire smaller roll in question is rejected as scrap.

This approach, however, can result in large amounts of waste, which is environmentally unsound and which ultimately increases the cost of printable media supplies to customers. For example, a customer may desire a 300 feet long roll of paper. However, if the manufacturer discovers a splice at the 290 feet mark, the entire 290 feet of paper rolled thus far may be discarded, and a new 300 feet long roll of paper rolled for the customer.

Examples of the present disclosure compensate for these problems. A machine-readable data pattern associated with at least the location of each physical defect on a printable media supply is generated and added to a printable media supply. The pattern can also include other information, such as the size of each physical defect. When the printable media supply is loaded onto a printing system, the printing system detects the pattern to determine the locations of the physical defects on the supply. A print job can then be printed on the printable media supply in such a way that takes into account the physical defects that are present.

For example, the operator of the printing system may be alerted as to the physical defects on the printable media supply. The operator, or the printing system itself automatically, may plan the printing of a print job on the printable media supply in a way that avoids the locations of the physical defects during printing, and/or that minimizes the impact of the physical defects on the print job. For instance, as to the latter, the print job may be printed on the printable media supply in such a way that the portion of the print job printed over a physical defect is not an important part of the print job.

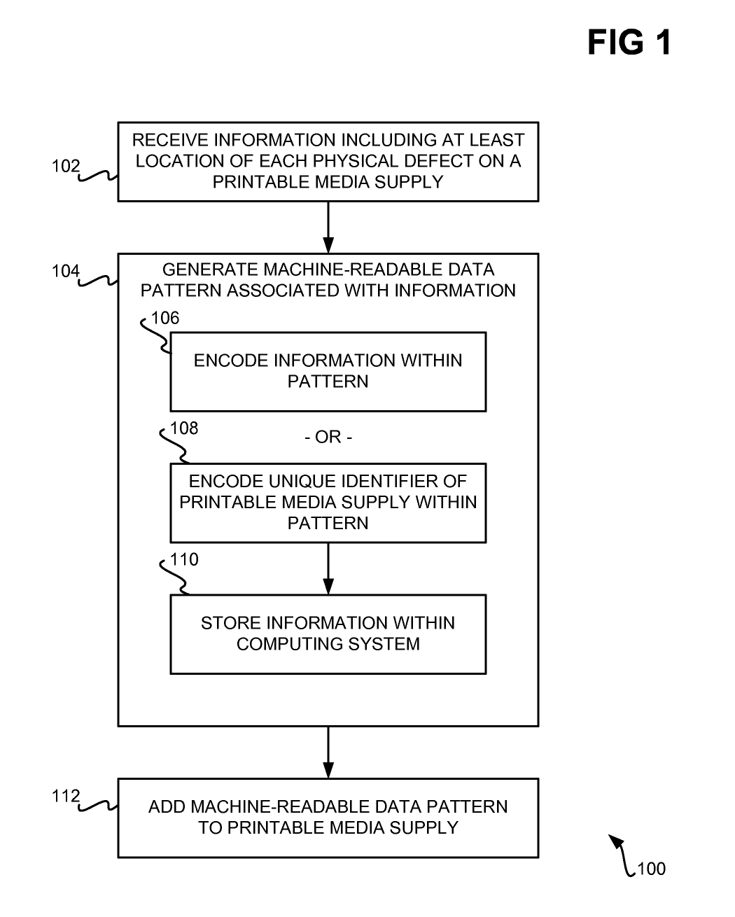

FIG. 1 shows a method 100, according to an example of the disclosure. The method 100 is performed after a printable media supply has been manufactured, but before the printable media supply has been shipped to a customer. The printable media supply may be a roll of paper, a roll of textile, or another type of printable media supply.

Information including at least the location of each physical defect on the printable media supply is received (102), such as from the manufacturer of the printable media supply. The location of each physical defect is typically determined during or shortly after the printable media supply has been manufactured, and is logged. It is noted that a physical defect in this respect is not a result of less than optimal printing on the printable media supply, which has not yet occurred, but rather is typically a result of the manufacturing process itself. For example, for coated media, some locations of the printable media supply may not have been coated properly, and each such location is considered a physical defect.

The location of each physical defect may be specified by at least two distance-related parameters. The first distance-related parameter specifies the location of a physical defect from an edge of the printable media supply, width-wise. The second distance-related parameter specifies the location of the physical defect from a beginning of the printable media supply, length-wise.

The distance-related parameters may be specified in customary distance units, such as centimeters, inches, and so on. The distance-related parameters may additionally or alternatively be specified in relation to how a printing system that will print on the printable media supply measures distance. For example, as to the width of the printable media supply, the printing system may measure the number of units that an encoder of a printing mechanism of the printing system records between a current position and an edge of the printable media supply.

As another example, as to the length of the printable media supply, a differential frequency encoding technique can be employed by the printing system to measure a current position of the printable media supply as the media supply is advanced through the printing system. One such differential frequency encoding technique that can be used in this manner is that which is described in the copending PCT patent application entitled “Media Roll Management,” filed on Mar. 19, 2009, and assigned serial number PCT/US2009/037718 (attorney docket no. 200803605-1). Other such techniques may also be employed.

The information received in part 102 may further include the size of each physical defect, and the type of each physical defect. As to the size of each physical defect, this information can be provided as the length and width of a physical defect relative to the location of the physical defect. For example, the location of the physical defect may be specified as the lower left-hand corner of the defect, and the size of the physical defect is then specified as how far the defect extends from this lower left-hand corner both in length and in width.

The size of each physical defect may alternatively or additionally be specified as an absolute pair of distance-related parameters that is used in conjunction with the location of the physical defect. For example, the location of a physical defect may be specified as the lower left-hand corner of the defect. The size of the physical defect is then provided by also specifying the location of the upper right-hand corner of the defect. In this example and the example of the previous paragraph, the physical defect is thus specified as a rectangle on the printable media supply.

As to the type of each physical defect, each physical defect may have a kind and/or a severity. The kind of a physical defect may indicate whether or not printing over the physical defect is possible. The severity of a physical defect may indicate the extent to which image quality is impaired when printing over the physical defect. This information, along with the location and size of the physical defect, can then be used to determine how printing on the printable media supply is to be achieved, taking into account the physical defects on the media supply.

The information received in part 102 can include other types of information as well, such as a unique identifier of the printable media supply in relation to other printable media supplies, the type of the printable media supply, the size of the printable media supply, and a stocking-keeping unit (SKU) of the printable media supply. For example, the type of the printable media supply may indicate the kind of paper, and so on, that the media supply is made up of. Because a customer may have a relatively large number of identical rolls, for instance, the unique identifier permits the customer to distinguish one roll from another. The size of the printable media supply may include the length and/or width of the media supply, and the SKU of the printable media supply may be used for accounting and other purposes.

A machine-readable data pattern is generated that is associated with the information received in part 102 (104). The machine-readable data pattern may be generated by a processor of a computing device executing a suitable computer program. The machine-readable data pattern is machine readable in that it is intended for reading by a machine, like a computing device, to read the data pattern, as opposed to by a human. Examples of machine-readable data patterns include one-dimensional bar codes, two-dimensional bar codes, as well as other types of such data patterns.

As one example, the information received in part 102 is encoded directly within the machine-readable data pattern (106). As such, the information can subsequently be decoded directly from the machine-readable data pattern. By comparison, as another example, just the unique identifier of the printable media supply is encoded directly within the machine-readable data pattern (108), and the other information is stored within a computing system (110), such as a database. The information is therefore retrieved by decoding the unique identifier directly from the machine-readable data pattern, and then looking up the information by the unique identifier within the computing system.

The machine-readable data pattern is added to the printable media supply (112). For example, the machine-readable data pattern may be printed on the printable media supply itself, such as at the beginning of the printable media supply. A printing device such as a laser printer or an inkjet printer may be used to print the machine-readable pattern on the printable media supply. As another example, the machine-readable data pattern may be printed on a label, which is then affixed to the printable media supply, such as at the beginning thereof. As a third example, the machine-readable data pattern may be encoded within a radio-frequency identification (RFID) member, or another type of wirelessly detectable member, which is then affixed or attached to the media supply.

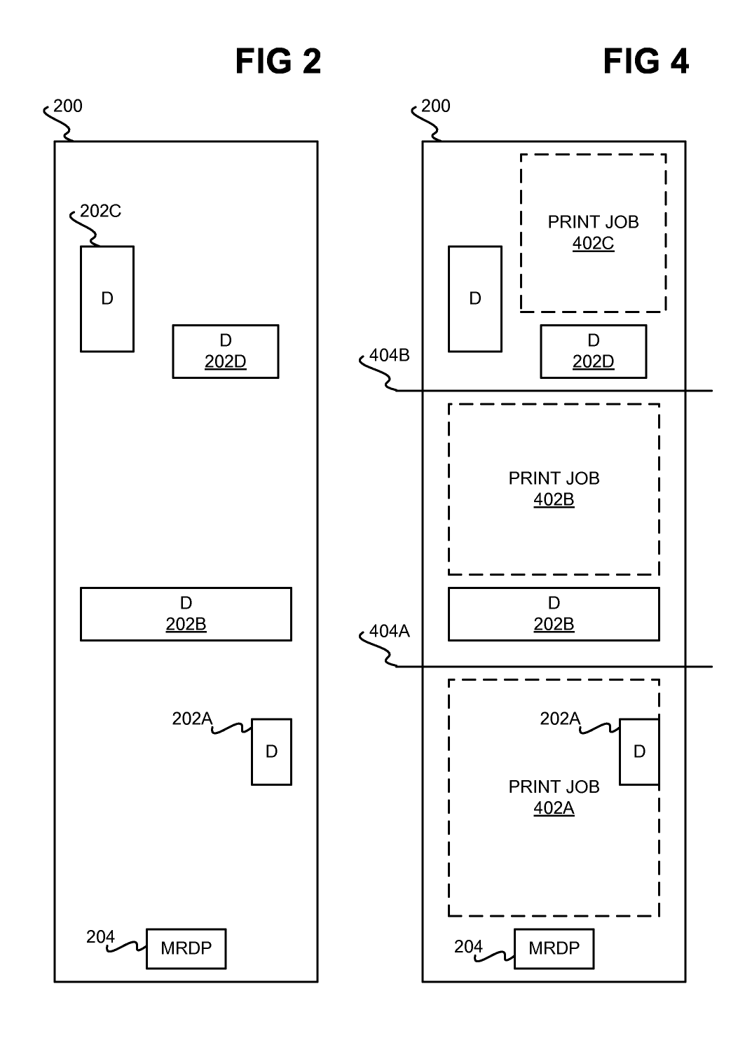

FIG. 2 shows a representative printable media supply 200, after the method 100 has been performed, according to an example of the disclosure. The printable media supply 200 includes defects 202A, 202B, 202C, and 202D, collectively referred to as the defects 202. Information including at least the locations of these defects 202 is received in part 102 of the method 100, and a machine-readable data pattern associated with this information is generated in part 104. In the specific example of FIG. 2, the machine-readable data pattern is printed at the beginning of the printable media supply in part 112, which is indicated as the machine-readable data pattern 204.

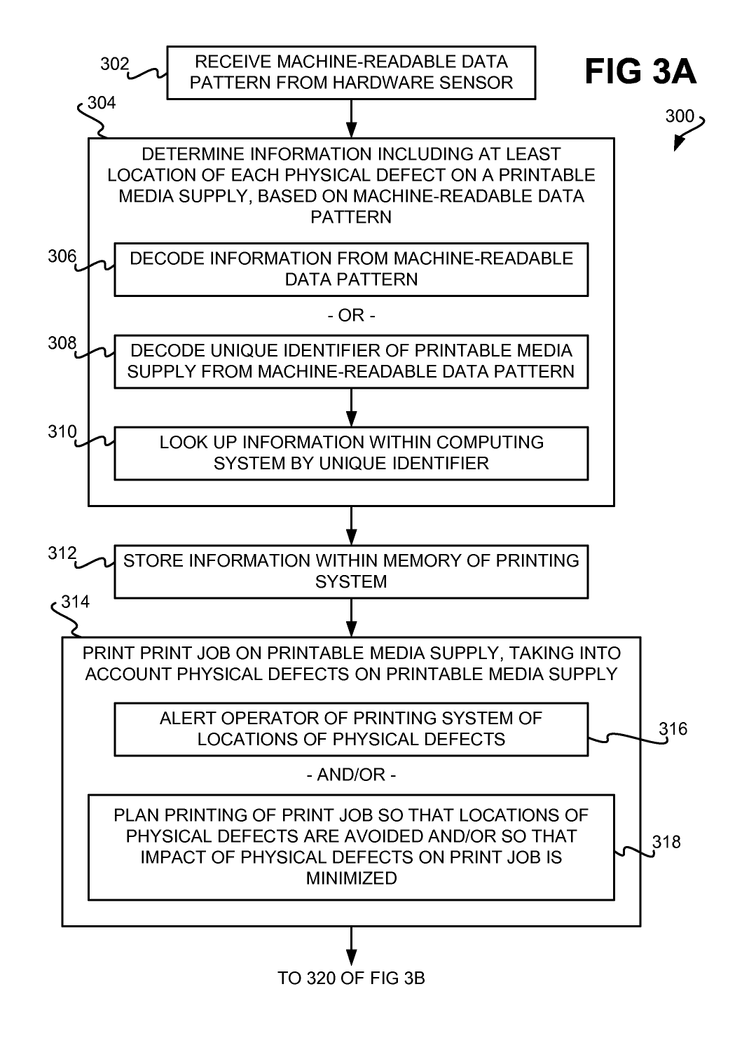

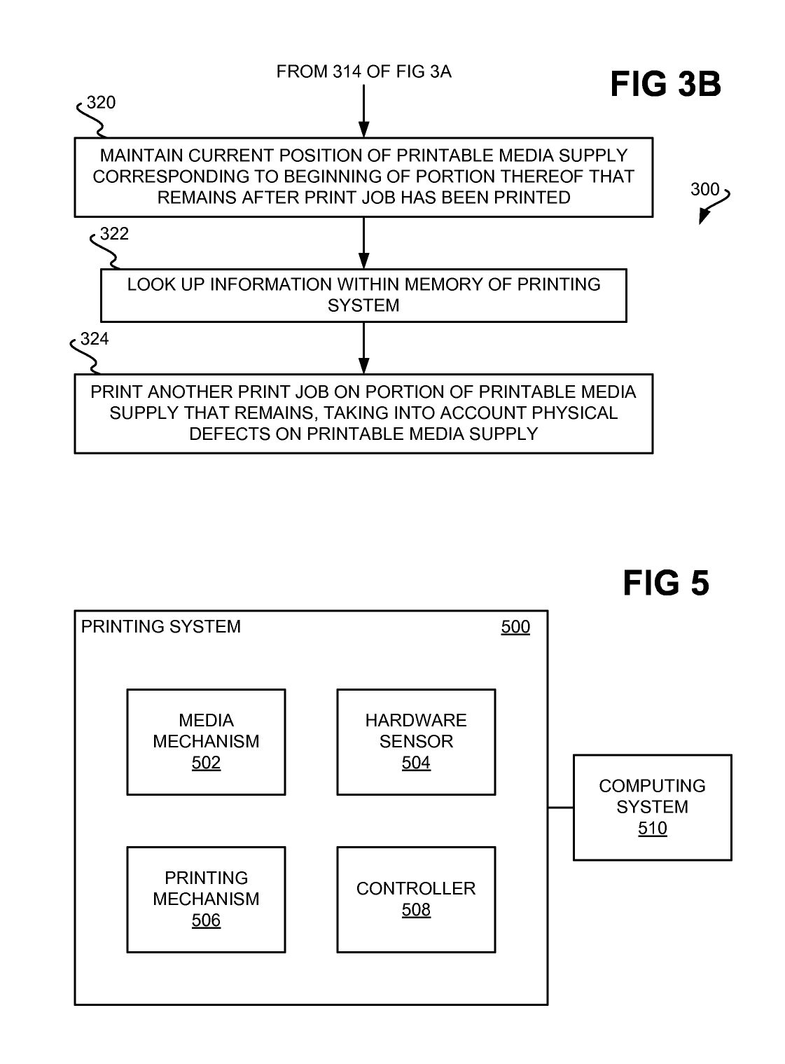

FIGS. 3A and 3B show a method 300, according to an example of the disclosure. The method 300 is performed after a printable media supply has been shipped to a customer and loaded onto a printing system. The method 300 is performed by the printing system itself, such as by a hardware unit of the printing system like a processor, a field-programmable gate array (FPGA), or an application-specific integrated circuit (ASIC). As such, the method 300 may be implemented as a computer program stored on a non-transitory computer-readable data storage medium that is executed by such a program-executing hardware unit of the printing system.

In FIG. 3A, a machine-readable data pattern is received from a hardware sensor of the printing system that detected the data pattern that was previously added to the printable media supply (302). Information, including at least the location of each physical defect on the printable media supply, as well as other information as has been described, is determined based on the machine-readable data pattern (304). For example, where the machine-readable data pattern directly encodes this information, the information is correspondingly directly decoded from the machine-readable data pattern (306).

As another example, where the machine-readable data pattern directly encodes just the unique identifier of the printable media supply, just the unique identifier is directly decoded from the machine-readable data pattern (308). The remainder of the information is then looked up within a computing system on which the information was previously stored, by the unique identifier (310). The computing system may be a different system than the printing system, or it may be a part of the printing system. The information is then stored within a memory of the printing system (312), so that the information for the current printable media supply can be retrieved later, too.

A print job is printed on the printable media supply in a way that takes into account the physical defects on the printable media supply (314), as to which the information has been determined in part 304. As one example, the operator of the printing system may be alerted to the locations of the physical defects (316), so that the operator can appropriately lay out the print job in relation to the printable media supply as desired prior to printing. As another example, the printing system itself can plan printing of the print job so that locations of the physical defects are avoided, and/or so that the impact of the physical defects on the print job is minimized (318).

It is noted that taking into account the physical defects on the printable media supply can include compensating for a given accuracy in which positions can be ascertained in relation to the printable media supply. If positions on the printable media supply can be ascertained with relatively high accuracy, then the locations of the physical defects can be accounted for by just, for instance, not printing at these locations. It is noted that the previously cited patent application provides for such accurate ascertaining of positions on the printable media supply with relatively high accuracy. However, if positions on the printable media supply cannot be ascertained with high accuracy, then the locations of the physical defects can be accounted for by not printing at these locations, within a margin of error around each such location.

For example, a square defect may start in accordance with a unit of measure at x and y coordinates five and five and end at x and y coordinates ten and ten. If these coordinates can be accurately ascertained in relation to the printable media supply, then the physical defect can be taken into account by ensuring that printing does not occur within the square space defined by the x and y coordinates five and five and the x and y coordinates ten and ten. However, if the coordinates cannot be so accurately ascertained, then the physical defect can be taken into account by ensuring that printing does not occur within the square space defined by the x and y coordinates (5−M) and (5−M) and the x and y coordinates (10+M) and (10+M). In this case, M stands for the margin of error in relation to which the positions on the printable media supply can be accurately ascertained.

Once the print job has been printed on the printable media supply, this portion of the printable media supply may be removed, leaving a remaining portion of the printable media supply. In FIG. 3B, the current position of the printable media supply, corresponding to the beginning of the remaining portion thereof, is maintained (320). This is so that when the remaining portion of the printable media supply is printed on, the physical defects on this remaining portion can be located using the information that was previously stored in part 312.

For example, a printable media supply may have a length divided between positions 0 and L1, and positions L1 and L2. The locations of the physical defects are specified length-wise in relation to position 0. The print job is printed in part 314 on the portion of the printable media supply between positions 0 and L1. The current position L1 is maintained, so that when another print job is printed, the locations of the physical defects on the remaining portion of the printable media supply can be ascertained. For instance, if there is a physical defect at a position L3 between positions L1 and L2, the length-wise location of this defect with respect to the current position L1 is known to be L3 minus L1. In this respect, when another print job is to be printed, on the portion of the printable media supply that remains, the information stored within the memory of the printing system in part 312 is looked up (322), and this additional print job is printed (324). As with printing of the print job in part 314, printing of the print job in part 324 takes into account the physical defects present on the printable media supply. Parts 320, 322, and 324 are ultimately repeated until the printable media supply has been used up.

As noted above, during printing of each print job by the printing system, the printing system can track the current position on the printable media supply both length-wise and width-wise. The printing system can track the current position width-wise by counting the number of units that an encoder of the printing system records between the edge of the printable media supply and the current position. The printing system can track the current position length-wise by using a differential frequency encoding technique.

FIG. 4 shows the printable media supply 200 of FIG. 2, after the method 300 has been performed to print three print jobs, according to an example of the disclosure. The machine-readable pattern 204 is detected by a hardware sensor and is transmitted to the hardware unit performing the method 300 in part 302. The location of each physical defect 202, as well as other information, is determined in part 304, and is stored within a memory of the printing system in part 312.

The print job 402A is then printed on the printable media supply, taking into account the physical defects 202 on the printable media supply 200, in part 314 of the method 300. For example, it may be determined that by printing the print job 402A as depicted in FIG. 4, the physical defect 202A will minimally impact the quality of the print job 402A. As such, the print job 402A is printed so that a portion of the print job 402A is printed directly over the physical defect 202A. The portion of the printable media supply 200 ending at the line 404A is then removed.

The current position of the printable media supply 200, corresponding to the line 404A, is maintained in part 320 of the method 300, and the information regarding at least the locations of the physical defects 202 is retrieved from the memory of the printing system in part 322. The print job 402B is then printed on the printable media supply 200, taking into account the physical defects 202 on the printable media supply 200, in part 324. For example, it may be determined that the size and/or severity of the physical defect 202B is too great to print the print job 402B over. As such, the printable media supply 200 is advanced so that the print job 402B starts past and thus avoids the physical defect 202B, as depicted in FIG. 4. The portion of the printable media supply 200 ending at the line 404B is then removed.

Parts 320, 322, and 324 are then repeated for the print job 402C. The current position of the printable media supply 200, corresponding to the line 404B, is maintained in part 320, and the information regarding at least the locations of the physical defects 202 is retrieved in part 322. The print job 402C is then printed on the printable media supply 200, taking into account the physical defects 202 on the printable media supply 200, in part 324. For example, it may be determined that the size of the print job 402C in relation to the sizes and locations of the physical defects 202C and 202D is such that printing of the print job 402C can begin just past the defect 202D and to the right of the defect 202C. As such, the physical defects 202C and 202D are avoided.

In conclusion FIG. 5 shows a representative printing system 500, according to an example of the disclosure. The printing system 500 may be implemented as a single printing device, such as a printer. The printing system 500 includes a media mechanism 502, a hardware sensor 504, a printing mechanism 506, and a controller 508.

The media mechanism 502 includes those physical and other parts of the printing system 500 that hold and advance a printable media supply. As noted above, the printable media supply may be a roll of paper, or another type of printable media supply. The hardware sensor 504 detects the machine-readable data pattern printed on the printable media supply. The hardware sensor 504 may be an optical sensor, for instance.

The printing mechanism 506 includes those physical and other parts of the printing system 500 that actually print a print job on the printable media supply as the media mechanism 502 advances the printable media supply. The printing mechanism 506 may include the encoder that has been described. The printing mechanism 506 may be an inkjet-printing mechanism, a laser-printing mechanism, or another type of dot-on-demand printing mechanism. A dot-on-demand printing mechanism can be considered a printing mechanism that is able to selectively print onto media in accordance with a desired pattern, such that pixels of the pattern can be individually addressable by the printing mechanism.

The controller 508 may be implemented in hardware, software, or a combination of hardware and software. For example, the controller 508 can be or include the program-executing hardware unit that has been described. The controller 508 performs the method 300 of FIG. 3. As such, the controller receives the machine-readable data pattern from the hardware sensor 504, and determines the locations of the physical defects on the printable media supply, as well as other information, based on or from this machine-readable data pattern. Finally, the controller 508 causes the printing mechanism 506 to print the print job on the printable media supply in a way that takes into account the physical defects on the printable media supply.

As depicted in FIG. 5, the printing system 500 can be communicatively connected to a computing system 510. The computing system 510 may include or be a desktop computer, a laptop computer, or another type of computing device. The computing system 510 may be the system that provides the printing system 500 with a print job to print on the printable media supply, such as text, graphics, or a combination of text and graphics. The computing system 510 may also or alternatively be the system that stores the information with which the machine-readable data pattern, as described above in relation to part 110 of FIG. 1 and in relation to part 310 of FIG. 3A.

We claim:

1. A method comprising:
receiving information comprising at least a location of each physical defect of a plurality of physical defects on a printable media supply;
generating a machine-readable data pattern associated with the information; and,
adding the machine-readable data pattern to the printable media supply.

2. The method of claim 1, wherein the information further comprises one or more of:
a unique identifier of the printable media supply;
a stock-keeping unit (SKU) of the printable media supply;
a type of the printable media supply;
a size of the printable media supply;
a size of each physical defect; and,
a type of each physical defect, including one or more of a severity and a kind of each physical defect.

3. The method of claim 1, wherein generating the machine-readable data pattern comprises encoding the information within the machine-readable data pattern.

4. The method of claim 1, wherein generating the machine-readable data pattern comprises encoding a unique identifier of the printable media supply within the machine-readable data pattern,
and wherein the method further comprises storing the information within a computing system such that the information is referenced within the computing system by the unique identifier.

5. A non-transitory computer-readable data storage medium storing a computer program to cause a program-executing hardware unit of a printing system to perform a method comprising:
receiving a machine-readable data pattern from a hardware sensor that detected the machine-readable data pattern added to a printable media supply, the machine-readable data pattern associated with information comprising at least a location of each physical defect of a plurality of physical defects on the printable media supply;
determining the information based on the machine-readable data pattern; and,
printing a print job on the printable media supply, taking into account the physical defects on the printable media supply.

6. The non-transitory computer-readable data storage medium of claim 5, wherein the information further comprises one or more of:
a unique identifier of the printable media supply;
a stock-keeping unit (SKU) of the printable media supply;
a type of the printable media supply;
a size of the printable media supply;
a size of each physical defect; and,
a type of each physical defect, including one or more of a severity and a kind of each physical defect.

7. The non-transitory computer-readable data storage medium of claim 5, wherein the information is encoded within the machine-readable data pattern,
and wherein determining the information based on the machine-readable data pattern comprises decoding the information from the machine-readable data pattern.

8. The non-transitory computer-readable data storage medium of claim 5, wherein determining the information based on the machine-readable data pattern comprises:
decoding a unique identifier of the printable media supply from the machine-readable data pattern; and,
looking up the information within a computing system on which the information is stored by referencing the information by the unique identifier.

9. The non-transitory computer-readable data storage medium of claim 5, wherein printing the print job on the printable media supply, taking into account the physical defects on the printable media supply, comprises:
alerting an operator of the printing system of the locations of the physical defects on the printable media supply.

10. The non-transitory computer-readable data storage medium of claim 5, wherein printing the print job on the printable media supply, taking into account the physical defects on the printable media supply, comprises:
planning the printing of the print job on the printable media supply such that one or more of:
the locations of the physical defects are avoided during the printing; and,
an impact of the physical defects on the print job is minimized.

11. The non-transitory computer-readable data storage medium of claim 5, wherein the print job is a first print job, and the method further comprises:
storing the information within a memory of the printing system;
after the first print job has been printed on the printable media supply has finished such that a portion of the printable media supply remains,
maintaining a current position of the printable media supply, corresponding to a beginning of the portion of the printable media supply that remains;
looking up the information within the memory of the printing system; and,
printing a second print job on the portion of the printable media supply that remains, taking into account the physical defects on the printable media supply.

12. A printing system comprising:
a media mechanism to hold and advance a printable media supply, the printable media supply having a machine-readable data pattern added thereto, the machine-readable data pattern associated with information comprising at least a location of each physical defect of a plurality of physical defects on the printable media supply;
a hardware sensor to detect the machine-readable data pattern added to the printable media supply;
a printing mechanism to print a print job on the printable media supply as the media mechanism advances the printable media supply; and,
a controller to receive the machine-readable data pattern from the hardware sensor, to determine the information based on the machine-readable data pattern, and to cause the printing mechanism to print the print job on the printable media supply while taking into account the physical defects on the printable media supply.

13. The printing system of claim 12, wherein the printable media supply comprises a roll of printable media.

14. The printing system of claim 12, wherein the information further comprises one or more of:
a unique identifier of the printable media supply;
a stock-keeping unit (SKU) of the printable media supply;
a type of the printable media supply;
a size of the printable media supply;
a size of each physical defect; and,
a type of each physical defect, including one or more of a severity and a kind of each physical defect.

15. The printing system of claim 12, wherein the controller is to take into account the physical defects on the printable media supply by planning the printing of the print job on the printable media supply such that one or more of:
the locations of the physical defects are avoided during the printing; and,
an impact of the physical defects on the print job is minimized
